(19) United States
(12) Patent Application Publication
(10) Pub. No.: US 2014/0306793 A1
(43) Pub. Date: Oct. 16, 2014

(54) High Q, Miniaturized LCP-Based Passive Components

(71) Applicant: King Abdullah University of Science and Technology, Thuwal (SA)

(72) Inventors: Atif Shamim, Thuwal (SA); Eyad Arabi, Thuwal (SA)

(73) Assignee: King Abdullah University of Science and Technology, Thuwal (SA)

(21) Appl. No.: 14/237,981

(22) PCT Filed: Aug. 15, 2012
(86) PCT No.: PCT/IB2012/001587

§ 371 Date: Apr. 14, 2014

Related U.S. Application Data
(60) Provisional application No. 61/524,490, filed on Aug. 17, 2011.

(51) Int. Cl. H01F 27/28

(52) U.S. Cl. CPC H01F 27/2804
USPC 336/200

(57) ABSTRACT

Various methods and systems are provided for high Q, miniaturized LCP-based passive components. In one embodiment, among others, a spiral inductor includes a center connection and a plurality of inductors formed on a liquid crystal polymer (LCP) layer, the plurality of inductors concentrically spiraling out from the center connection. In another embodiment, a vertically intertwined inductor includes first and second inductors including a first section disposed on a side of the LCP layer forming a fraction of a turn and a second section disposed on another side of the LCP layer. At least a portion of the first section of the first inductor is substantially aligned with at least a portion of the second section of the second inductor and at least a portion of the first section of the second inductor is substantially aligned with at least a portion of the second section of the first inductor.

### CROSS REFERENCE TO RELATED APPLICATIONS

This application is the National Stage of International Application No. PCT/IB2012/001587, filed Aug. 15, 2012, which claims the benefit of and priority to U.S. provisional application No. 61/524,490, filed Aug. 17, 2011, the contents of all of which are incorporated by reference as if fully set forth herein.

### TECHNICAL FIELD

The present disclosure discloses embodiments of high Q, miniaturized passive components.

### BACKGROUND

In electronic devices, size is always a consideration to achieve higher mobility. Integrated circuit (IC) chips have been miniaturized to the point where they account for only 10% of the overall system size. The remaining 90% of the system consists of input/output modules, heat sinks, surface mounted passives, interconnects, power sources, etc. Additional reduction in size can be achieved by integrating these components within the packaging of the system.

### SUMMARY

Embodiments of the present disclosure are related to high Q, miniaturized liquid crystal polymer (LCP) based passive components and applications thereof. Multilayer LCP (M-LCP) passive components can be produced using an adhesiveless LCP process to form electrical circuits for use on printed circuit boards (PCB). LCP passive components can include, for example, spiral inductors including multiple inductor coils, and vertically intertwined inductors. The components may include a vertical interdigitized (VID) capacitor including a plurality of plates separated by at least one LCP layer. LCP passive components may be distributed between a plurality of LCP layers to reduce the area of the M-LCP circuit.

In one embodiment a spiral inductor is provided including: a center connection; and a plurality of inductors formed on a liquid crystal polymer (LCP) layer, the plurality of inductors concentrically spiraling out from the center connection. The spiral inductor may include a metallized via providing a connection path through the LCP layer to the center connection. Furthermore, the plurality of inductors may consist of two inductors that concentrically spiral out from the center connection. At least one of the plurality of inductors may have a number of turns (N) that is a fractional number of turns. Also, a first inductor and a second inductor of the plurality of inductors may have a different number of turns (N).

In another embodiment a vertically intertwined inductor is provided including: a first inductor including: a first section disposed on a first side of a liquid crystal polymer (LCP) layer, the first section forming a fraction of a turn; and a second section disposed on a second side of the LCP layer, the first section forming a fraction of a turn, the second section connected to the first section through a via passing from the first side to the second side through the LCP layer; and a second inductor including: a first section disposed on the first side of the LCP layer, the first section forming a fraction of a turn; and a second section disposed on the second side of the LCP layer, the first section forming a fraction of a turn, the second section connected to the first section through a via passing from the first side to the second side through the LCP layer; where at least a portion of the first section of the first inductor is substantially aligned with at least a portion of the second section of the second inductor and at least a portion of the first section of the second inductor is substantially aligned with at least a portion of the second section of the first inductor. The first and second inductors may be circular inductors. The first inductor or the second inductor or both the first and second inductors may include a third section. For example, a third section of the first inductor may be included, the third section forming a fraction of a turn, the third section connected to the second section of the first inductor through a via passing through another LCP layer, wherein at least a portion of the third section of the first inductor is substantially aligned with at least a portion of the second section of the second inductor. Also, for example, a third section of the second inductor may be included, the third section forming a fraction of a turn, the third section connected to the second section of the second inductor through a via passing through the other LCP layer, at least a portion of the third section of the second inductor is substantially aligned with at least a portion of the second section of the first inductor.

In yet another embodiment, an adhesiveless multilayer LCP circuit is provided. For example, the adhesiveless multilayer LCP circuit may include either the aforementioned spiral inductor or the aforementioned vertical entwined inductor or both such inductors. The LCP layers of the circuit may include an ULTRALAM® 3850 layer and an ULTRALAM® bondply layer. The LCP layers of the circuit may have different thicknesses. Also, the adhesiveless multilayer LCP circuit may include a vertical interdigitized (VID) capacitor including a plurality of plates separated by at least one LCP layer, preferably though not necessarily at least three plates separated by LCP layers. The VID capacitor may include a plurality of levels of interdigitated plates. As a non-limiting example the adhesiveless multilayer LCP circuit may be a radio frequency (RF) filter.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a graphical representation of a conventional multilayer LCP (M-LCP) in accordance with various embodiments of the present disclosure.

FIGS. 2A and 2B are graphical representations of examples of adhesiveless M-LCPs including metallization in accordance with various embodiments of the present disclosure.

FIG. 3 is a chart illustrating an example of a lamination process to form an adhesiveless M-LCP of FIGS. 2A and 2B in accordance with various embodiments of the present disclosure.

FIGS. 4(a) and 4(b) show views of examples of spiral inductors in accordance with various embodiments of the present disclosure.

FIGS. 5 and 6 show plots of O-factor and inductance of various spiral inductors of FIG. 4 in accordance with various embodiments of the present disclosure.

FIGS. 7(a)-7(c) show views of a spiral inductor including a plurality of circular inductors in accordance with various embodiments of the present disclosure.

FIGS. 8(a) and 8(b) show views of an example of a vertically intertwined circular inductor including a plurality of circular inductors in accordance with various embodiments of the present disclosure.

FIGS. 9(a) and 9(b) show views of examples of vertical interdigitized (VID) capacitors in accordance with various embodiments of the present disclosure.

FIG. 10 shows plots of capacitance of various VID capacitors of FIG. 9 in accordance with various embodiments of the present disclosure.

FIGS. 11(a)-11(c) are graphical representations of an example of a VID capacitor including a plurality of levels of interdigitated plates in accordance with various embodiments of the present disclosure.

FIGS. 12(a) and 12(b) illustrate the reduction in area of a Chebyshev high pass filter when implemented using LCP-based passive components of FIGS. 4, 9(a), and 9(b) in accordance with various embodiments of the present disclosure.

FIG. 13 shows plots of insertion and return losses of the high pass filter of FIGS. 12(a) and 12(b) in accordance with various embodiments of the present disclosure.

FIG. 14 is a graphical representation of an example of an implementation of another filter using LCP-based passive components of FIGS. 4(a), 4(b), and 9(a) in accordance with various embodiments of the present disclosure.

FIG. 15 is a circuit diagram for a band pass filter in accordance with various embodiments of the present disclosure.

FIGS. 16-21 and 24 are graphical representations of examples of implementations of the filter of FIG. 15 using LCP-based passive components in accordance with various embodiments of the present disclosure.

FIGS. 22 and 25 are pictures illustrating the fabricated band pass filters of FIGS. 21 and 24, respectively, in accordance with various embodiments of the present disclosure.

FIGS. 23 and 26 show plots of insertion and return losses of the band pass filters of FIGS. 21 and 24, respectively, in accordance with various embodiments of the present disclosure.

### DETAILED DESCRIPTION

Disclosed herein are various embodiments of systems and methods related to high Q, miniaturized liquid crystal polymer (LCP) based passive components and applications thereof. Reference will now be made in detail to the description of the embodiments as illustrated in the drawings, wherein like reference numbers indicate like parts throughout the several views.

Currently, electronic systems such as radio frequency (RF) systems consist of printed circuit boards (PCB), where other components and integrated circuits (IC) are mounted on top of the PCB. To integrate passive components with high degree of miniaturization, multi-layer technologies can be used. Low-temperature co-fired ceramic (LTCC) is an excellent multi-layer technology, which has matured over the years to provide robust low cost solutions. LTCC passives have very high quality factors and small form factors. However, the LTCC process is not compatible with PCBs.

On the other hand, liquid crystal polymer (LCP) can be used in a multi-layer scheme to provide similar advantages to LTCC in addition to better high temperature and high frequency performance. LCP is an organic material and, therefore, is perfectly compatible with PCB, which makes it very attractive for system on package (SoP) applications. Multilayer LCP (M-LCP) inductors and capacitors can be produced using an adhesiveless LCP process.

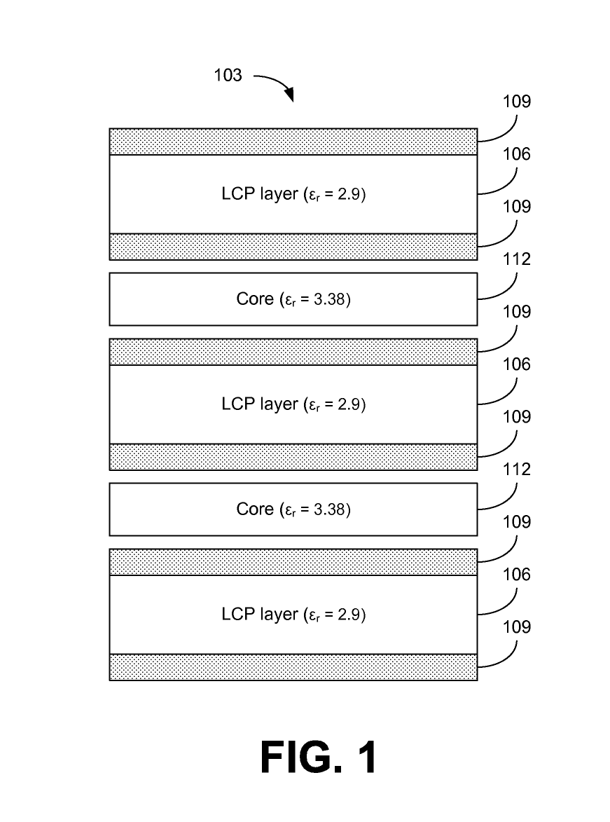

Referring to FIG. 1, shown is a graphical representation of a conventional M-LCP 103 with multiple LCP layers 106 including metallization 109 such as, e.g., copper foils applied to both sides of the LCP substrates. In the conventional M-LCP 103, individual LCP layers 106 are etched separately and then put together before pass-through holes or vias are drilled. Unlike LTCC, adequate bonding between the metallization and the LCP substrates cannot be accomplished easily. Therefore, adhesive layers 112 with different electrical and thermal properties are employed between LCP layers 106.

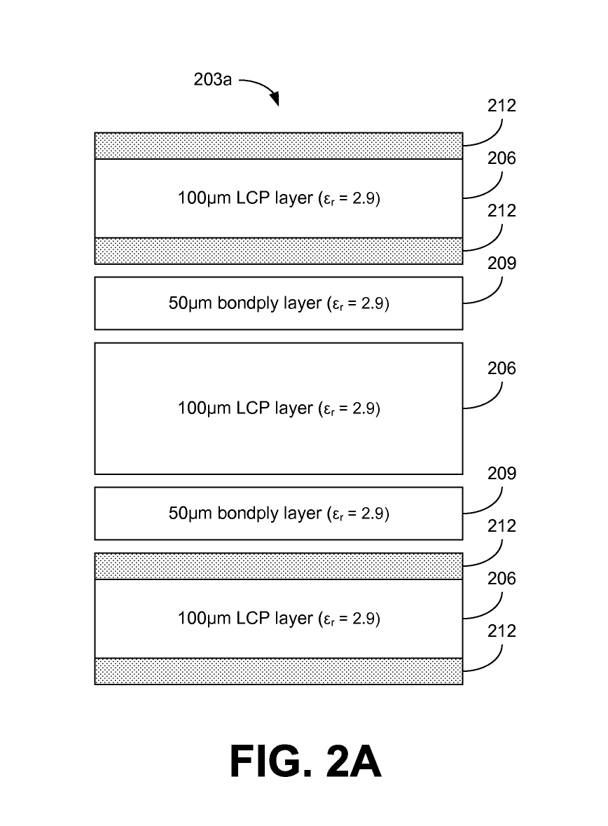

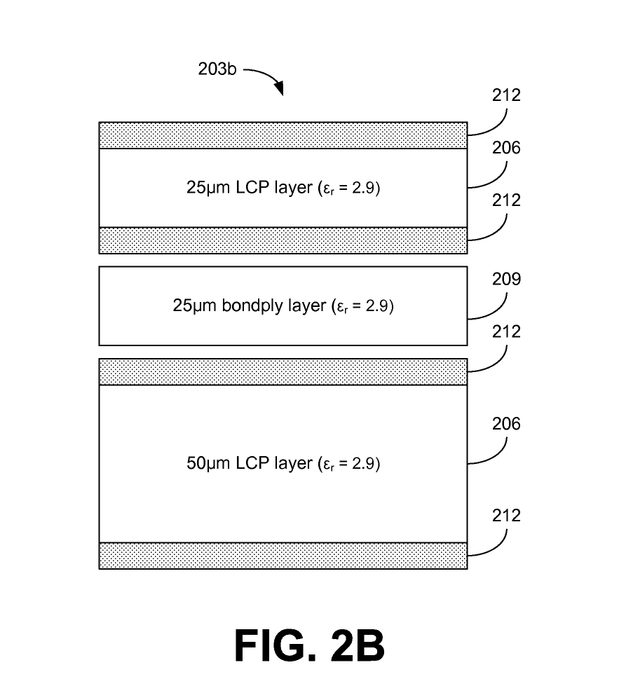

We now describe various embodiments of systems and methods of our present disclosure. Referring next to FIG. 2A, shown is a graphical representation of an example of an adhesiveless M-LCP 203a. In adhesiveless implementations, an LCP substrate is used as a bonding layer. For example, two LCP substrates 206 and 209 such as, e.g., ULTRALAM® 3850 and ULTRALAM® 3908 bondply by Rogers Corp. may be used. The ULTRALAM® 3850 can be used as the main LCP substrate 206 with a thickness of, e.g., 100 microns and with metallization 212 on both sides. The ULTRALAM® 3908, on the other hand, can be used as an adhesive layer 209 with a thickness of, e.g., 50 microns. Both of these substrates share the same electric properties (εᵣ=2.9, tan δ=0.0025), and therefore, the effect of the bondply layer 209 is seamless to the designer and the configuration is completely adhesiveless. Other thicknesses of LCP substrate may be used to provide equal or unequal distances between the metallization 212. For example, if a larger spacing is desired between the two 3850 layers 206, a combination of ULTRALAM® 3908 and/or etched ULTRALAM® 3850 may be used. In the embodiment of FIG. 2A, the total height of the M-LCP 203a is about 400 microns.

Referring now to FIG. 2B, shown is a graphical representation of another example of an adhesiveless M-LCP 203b. In the example of FIG. 2B, two LCP substrates 206 and 209 such as, e.g., ULTRALAM® 3850 and ULTRALAM® 3908 bondply by Rogers Corp. may be used. The ULTRALAM® 3850 can be used as the main LCP substrates 206 with a thickness of, e.g., 25 and 50 microns and with metallization 212 on both sides. The ULTRALAM® 3908 can be used as an adhesive layer 209 between the metallized substrates with a thickness of, e.g., 25 microns. Both of these substrates share the same electric properties (εᵣ=2.9, tan δ=0.0025), and therefore, the effect of the bondply layer 209 is seamless to the designer and the configuration is completely adhesiveless. Other thicknesses of LCP substrate may be used to provide equal or unequal distances between the metallization 212. In the embodiment of FIG. 2B, the total height of the M-LCP 203a is about 136 microns.

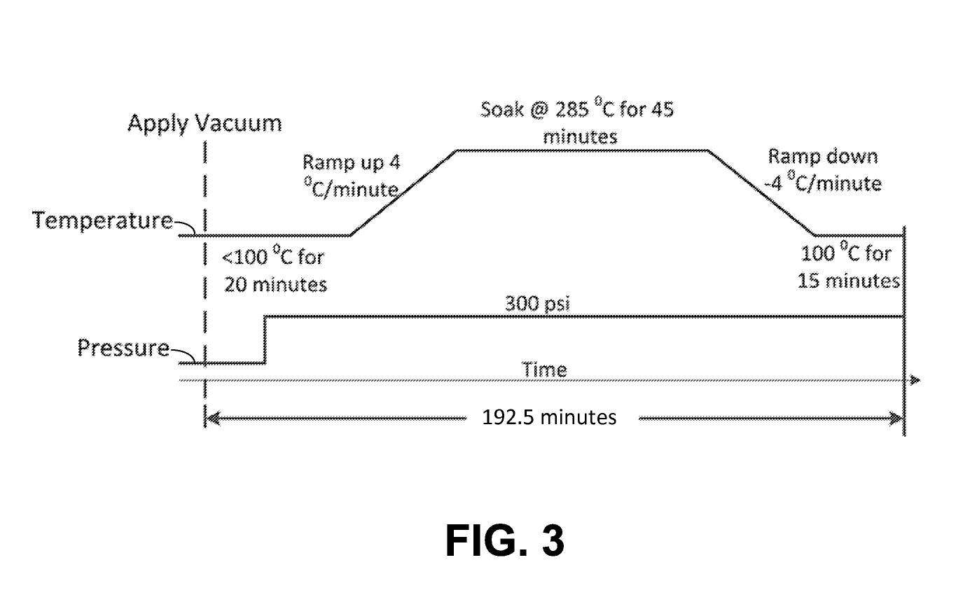

Referring to FIG. 3, shown is an example of a lamination process to form an adhesiveless M-LCP of FIGS. 2A and 2B. After etching the metallization 212 and forming the vias (e.g., by punching and metallization), the layers are aligned in a stack. Lamination release sheets can be used to avoid attaching the LCP films to the laminator. Initially, a vacuum is applied at a temperature below 100° C. After about 5 minutes, a pressure of about 300 psi is applied to the M-LCP. About 15 minutes later, the temperature is ramped up at about 4° C./minute to about 285° C. The temperature is maintained for 45 minutes before ramping down to about 100° C. at a rate of about −4° C./minute. The temperature is maintained at about 100° C. for about 15 minutes before the pressure is removed.

Adhesiveless M-LCP designs have many advantages over the conventional M-LCP using adhesive layers. Adhesiveless M-LCPs have less overall thickness and the via holes made in adhesiveless layers are more reliable. Moreover, adhesiveless substrates are thermally more stable. Generally, the adhesive layers have higher coefficients of thermal expansion (CTE), which causes fabrication difficulty. Finally, adhesiveless layers have higher degree of flatness and, therefore, are perfectly compatible with PCBs.

A variety of multilayer LCP-based passive components such as inductors and capacitors may be produced with the adhesiveless LCP layers. Inductors are integral components for all RF/microwave designs. Generally, it is not possible to obtain high O-factors for inductors fabricated on the chip. Surface mounted inductors can provide high O-factors, however, their inductance values are fixed and cannot be scaled, and they occupy large areas. The M-LCP design allows inductors to be vertically integrated within the package of the system leaving the area on the surface for other components. Capacitors have inherently much larger quality factors than inductors. Therefore, when designing a capacitor it is only necessary to get the desired capacitance. M-LCP design allows capacitors to be fabricated in vertical interdigitized (VID) configurations.

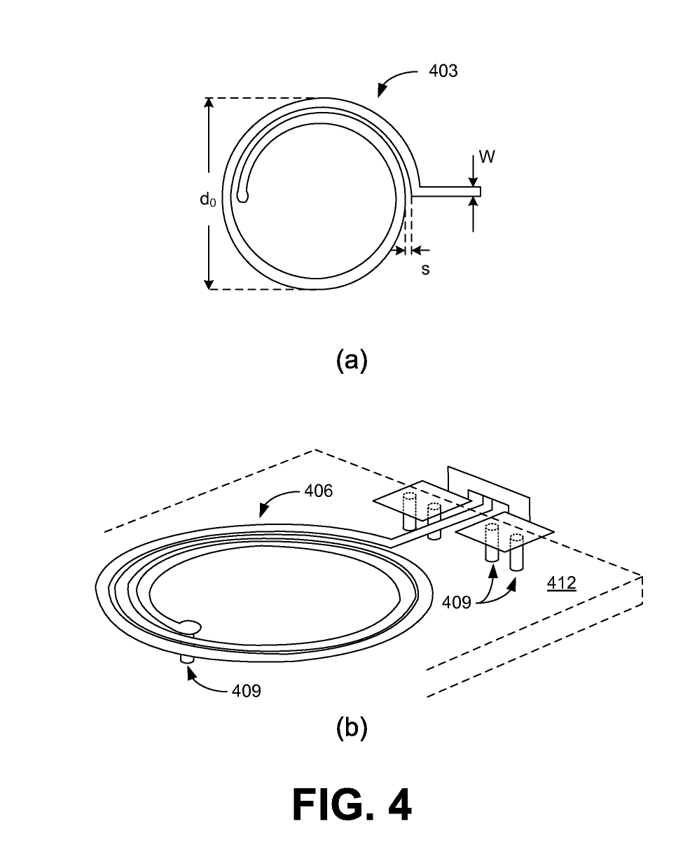

Referring to FIGS. 4(a) and 4(b), shown are examples of spiral inductors in accordance with various embodiments of the present disclosure. To be able to get inductances in the order of a few nHs, longer lengths of inductors are required. This may be achieved by using spiral inductors. There are two types of spiral inductor configurations: rectangular and circular. Circular inductors are believed to have better performances than their rectangular counterparts. The example of FIG. 4(a) is a top view of a one and a half turn circular inductor 403. The main design parameters of a circular inductor are line width (W), spacing (s), outer diameter (d₀), and the number of turns (N). The number of turns may be a fraction of a turn (e.g., N=¾), a single turn (e.g., N=1), a plurality of turns (e.g., N=3), or a combination of one or more whole turns and a fractional turn (e.g., N=1¾). FIG. 4(b) is a perspective view of a two and a half turn circular inductor 406. Vias 409 extend through the LCP layer 412 for connection to the circular inductor 406. High Q inductors with a reasonable amount of inductance (few nHs) are desirable for circuits such as matching networks and filters.

Full wave simulations using commercial software HFSS from Ansoft was used to obtain accurate design simulations. To simulate the inductors, a one port model is used with the other port shorted through a via as illustrated in FIG. 4(b). A ground-signal-ground coplanar waveguide (CPW) structure is used as a feed for the inductor to facilitate measurements. Using this configuration, the effective inductance (L_{eff}) and Q-factor can be calculated from:

L_{eff}=im{Z11}/(2πf) EQN. (1)

Q=im{Z11}/re{Z11} EQN. (2)

where L_{eff} is the effective inductance in Henry, f is the frequency in Hz, im{Z11} and re{Z11} represent the imaginary and real parts of Z11, respectively.

TABLE I summarizes the dimensions and performance of the modeled inductors. As shown in TABLE I, increasing the diameter of the inductor has the effect of increasing the inductance, but at the same time decreasing the self-resonance frequency (SRF). The same effect occurs when the number of turns is increased. Higher inductances and O-factors can also be obtained by decreasing the ratio s/W, but this also results in reduction in the SRF.

TABLE I

| | | | d0 | Qmax | L [nH] | SRF |
|---|---|---|---|---|---|---|
| # | N | s/W | [mm] | @ f [GHz] | @1.5 GHz | [GHz] |
| 1 | 0.5 | 0.3 | 1.1 | 150@8 | 1 | 17 |
| 2 | 0.5 | 0.3 | 2.5 | 125@4.5 | 2 | 9 |
| 3 | 2.5 | 0.3 | 1.1 | 75@4.5 | 2 | 11.5 |
| 4 | 2.5 | 0.3 | 2.5 | 80@1.5 | 13.5 | 2.7 |
| 5 | 1.5 | 0.5 | 1.2 | 85@3 | 5 | 6.5 |
| 6 | 1.5 | 0.5 | 2.5 | 70@1.5 | 17 | 2.5 |
| 7 | 1.5 | 1 | 1.2 | 70@2.2 | 8 | 5.5 |
| 8 | 1.5 | 1 | 2.5 | 60@1.5 | 25 | 2.2 |

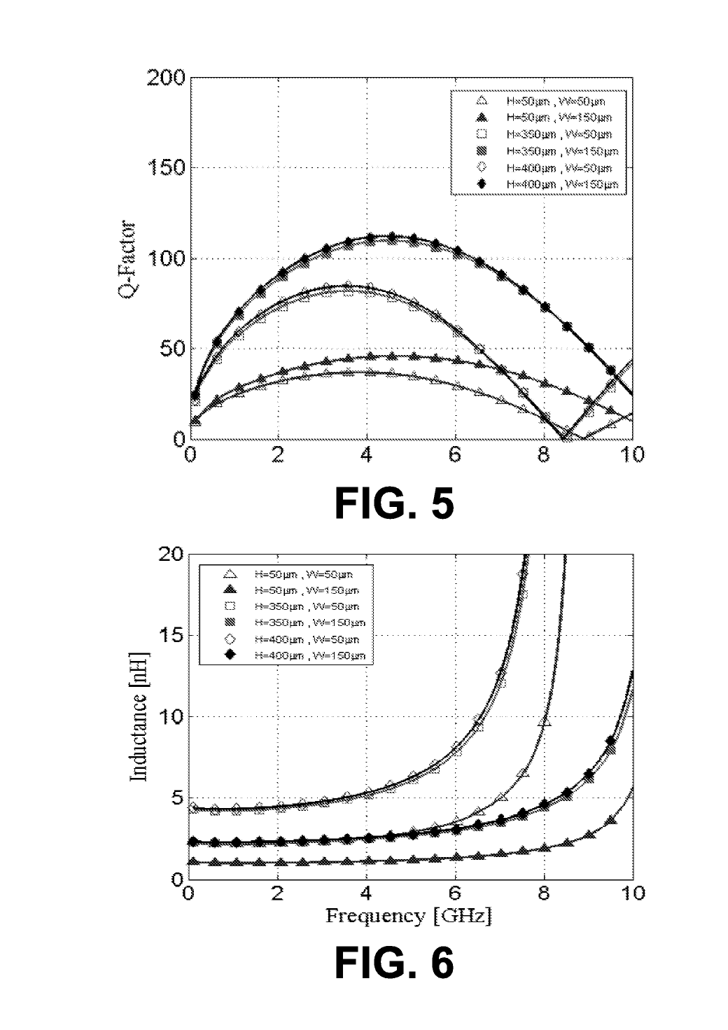

The ratio between winding spacing, and the width of the line (s/W) has a big effect on the O-factor. This is illustrated in FIG. 5, where the thickness of the substrate, H, is also varied. It can be seen that as the ratio s/W is decreased, the O-factor increases. Increasing the substrate thickness, H, has a similar effect over Q. Increasing s/W and/or increasing H has the effect of increasing the effective inductance and decreasing the SRF as shown in FIG. 6. When the thickness of the substrate, H, is increased, the parasitic capacitance between the inductor and the ground decreases, moreover, the eddy current on the ground plane due to fields generated by the inductor, is also decreased. Both these effects result in an increase in the inductance as well as the Q-factor. Therefore, in designing a high Q inductor, it is desirable to increase the thickness of the LCP substrate.

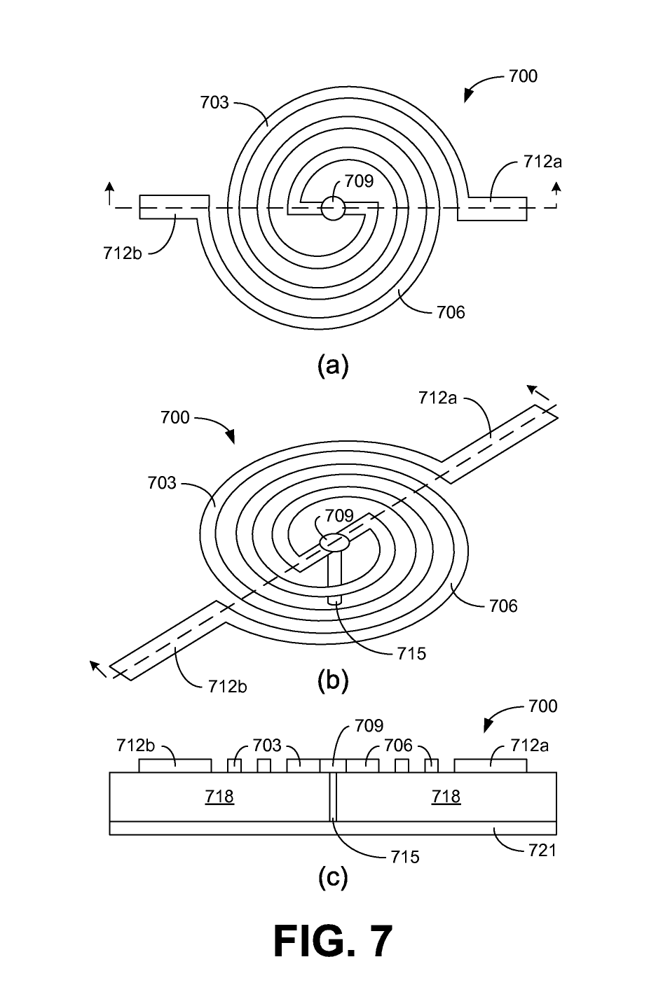

Referring next to FIGS. 7(a)-7(c), shown is an example of a spiral inductor 700 including a plurality of circular inductors that concentrically spiral out from a center connection. The example of FIG. 7(a) is a top view of the spiral inductor 700 including two inductors 703 and 706. The first inductor 703 is a one and a half turn coil that is connected to one side of the center connection 709 and spirals outward to a connection trace 712a. The second inductor 706 is also a one and a half turn coil that is connected to the other side of the center connection 709 and spirals outward between the coils of the first inductor 703 to another connection trace 712b. The concentric placement of the intertwined circular inductors 703 and 706 can achieve a high mutual coupling while maintaining a compact size.

FIG. 7(b) is a perspective view of the spiral inductor 700. A via 715 can extend (e.g., by punching and metallization) through an LCP layer 718 to provide a connect path to the center connection 709. As illustrated in the cross-sectional view of FIG. 7(c), the center connection 709 may be connected to metallization 721 (e.g., a ground plane) formed on the opposite side of the LCP layer 718 through via 715. The number of turns may be a fraction of a turn (e.g., N=¾), a single turn (e.g., N=1), a plurality of turns (e.g., N=3), or a combination of one or more whole turns and a fractional turn (e.g., N=1¾). In addition, inductors may have a different number of turns. Vias may extend through the LCP layer 718 to provide a connection path to the end connection 712 of one or more inductors. Also, while the example of FIGS. 7(a)-7(c) depict two mutually coupled inductors 703 and 706, additional inductors (e.g., three, four, or more) may be concentrically intertwined in other implementations as can be understood.

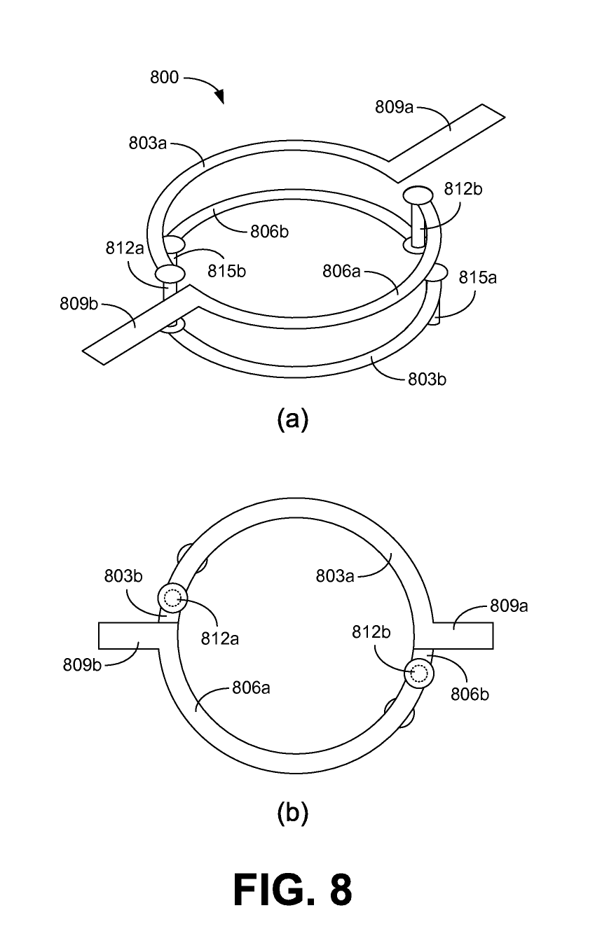

Referring now to FIGS. 8(a) and 8(b), shown is an example of a vertically intertwined inductor 800 including a plurality of circular inductors. In alternative embodiments, the vertically intertwined conductor 800 may be implemented with a plurality of rectangular inductors. FIG. 8(a) is a perspective view and FIG. 8(b) is a top view of the vertically intertwined inductor 800 including two inductors 803 and 806. The first inductor 803 is connected to a first end to a connection trace 809a. A first section 803a of the first inductor 803 completes a fraction of a turn on one side of an LCP layer (not shown for clarity) and a second section 803b of the first inductor 803 completes a fraction of a turn on the other side of the LCP layer. The first section 803a and second section 803b are connected through a via 812a. Another via 815a may be used to connect to the second end of the first inductor 803. Similarly, the second inductor 806 is connected to a first end to a connection trace 809b. A first section 806a of the first inductor 806 completes a fraction of a turn on one side of an LCP layer (not shown for clarity) and is connected to a second section 806b of the first inductor 806 through via 812b. Another via 815b may be used to connect to the second end of the second inductor 806.

As can be seen in FIGS. 8(a) and 8(b), at least a portion of the first section 803a of the first inductor is substantially aligned with at least a portion of the second section 806b of the second inductor and at least a portion of the first section 806a of the second inductor is substantially aligned with at least a portion of the second section 803b of the first inductor. In this way, the first and second inductors 803 and 806 are vertically intertwined to achieve a high mutual coupling while maintaining a compact size. In the example of FIG. 8, the first and second sections of both inductors are less than one half of a turn. Additional mutual coupling may be achieved by connecting one or more additional section(s) through via 815 to extend the first and/or second inductors 803 and 806.

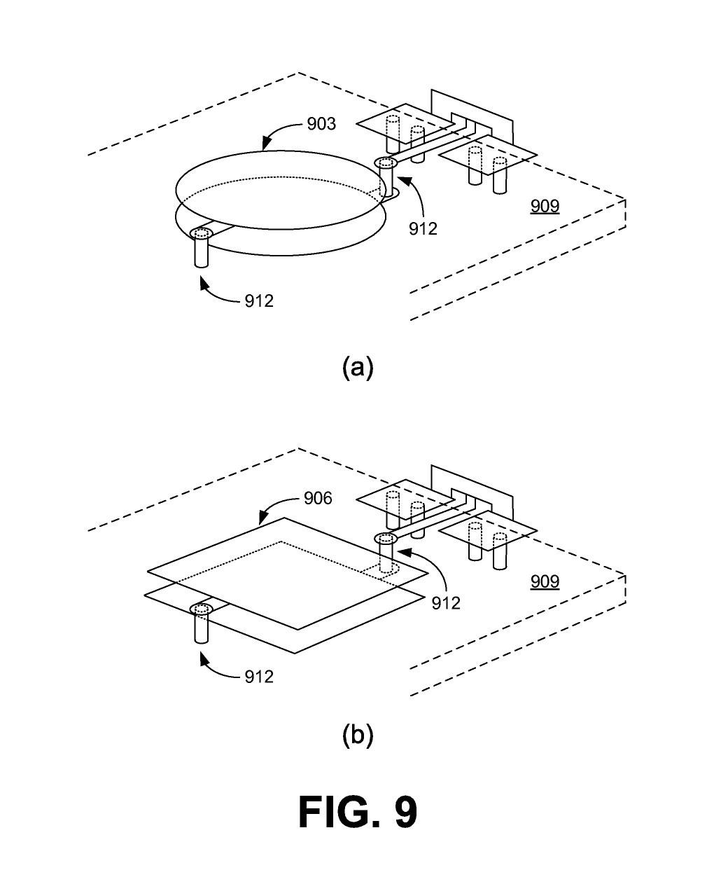

Multilayer LCP-based passive components also include capacitors that, in general, have larger quality factors than. With multi-layer technologies, capacitors can be fabricated in vertical interdigitized (VID) configurations including a plurality of parallel plates. FIGS. 9(a) and 9(b) show structures of VID capacitors with (a) circular plates 903 and (b) rectangular plates 906. In these embodiments, plates 903 and 906 are patterned in the metallization on opposite sides of the LCP layer 909. Vias 912 provide connection paths through the LCP layer 909. The capacitance of both cross-sections depends on the area of the plates rather than their shapes. Therefore, either shape may be used without a difference in performance. A rough estimation of the capacitance can be obtained from the classical relation:

C[F]=ε(N−1)A[m²]/d[m], EQN. (3)

where A is the area of the plate, d is the vertical distance between plates, and N is the number of vertical plates. Additional parallel plates may also be included.

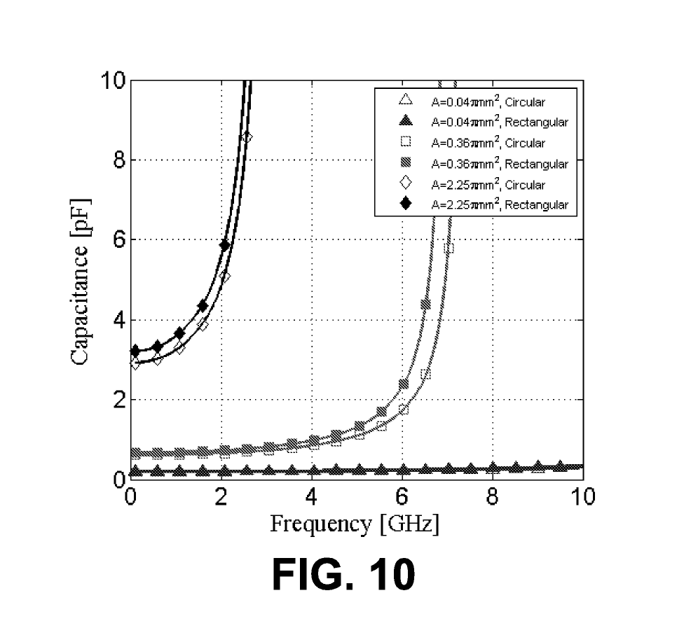

The capacitors were modeled in HFSS using the same feed structure as that used for the inductors. FIG. 10 shows the results of a full wave simulation of three layer circular and rectangular capacitors. From FIG. 10, it can be seen that as the area of the capacitor is increased, the capacitance increases. Furthermore, there is no remarkable performance difference between the rectangular and the circular capacitors. The capacitors with rectangular plates 906 tend to have slightly higher capacitance as compared to the capacitors with circular plates 903 with the same area and number of plates. This can be attributed to the fact that circular structures have higher series inductances and therefore, a lower SRF.

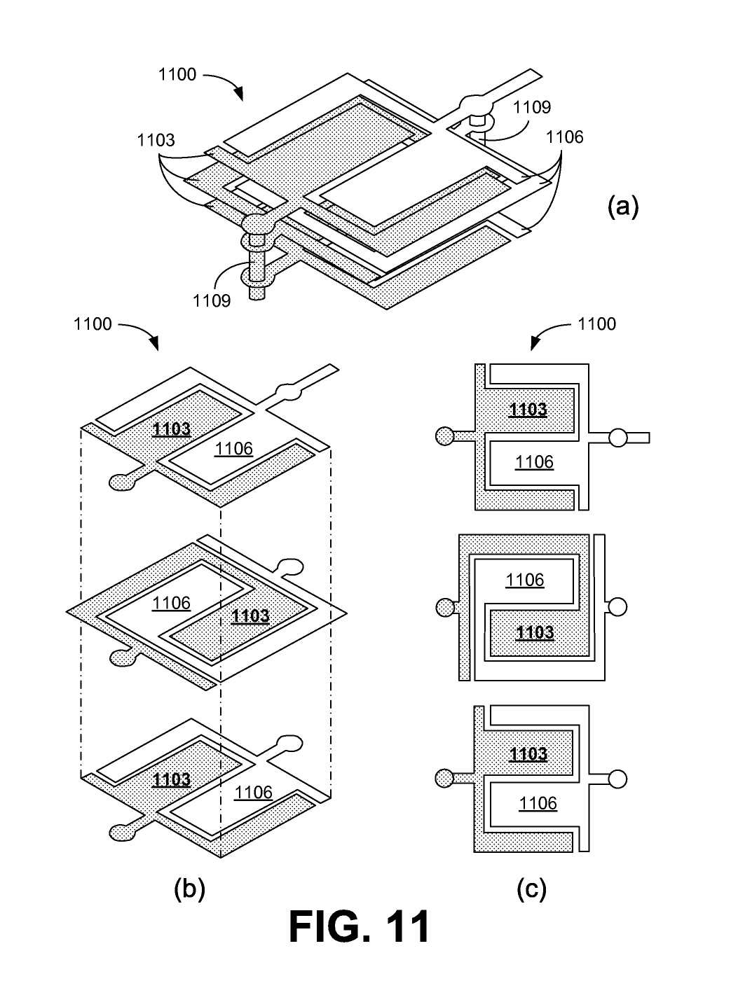

Referring next to FIGS. 11(a) through 11(c), shown is an example of a VID capacitor 1100 including a plurality of levels of interdigitated plates separated by layers of LCP (not shown for clarity). The capacitor plates 1103 and 1106 include one or more fingers that are interdigitated both horizontally and vertically and interconnected through vias 1109. Vias and/or traces can be used to provide connection paths to the VID capacitor 1100. In the example of FIGS. 11(a)-11(c), the capacitor plates 1103 and 1106 have an unequal vertical separation. In other embodiments, the capacitor plates 1103 and 1106 may be uniformly separated. FIG. 11(b) shows an exploded view and FIG. 11(c) shows a top view of the plate levels of the VID capacitor 1100 to illustrate the alignment of the interdigitated plates 1103 and 1106. While the example of FIGS. 11(a)-11(c) depict three plate levels, in other implementations two, four, or more levels may be utilized to provide the appropriate capacitance. The horizontal and vertical interdigitation of the capacitor plates 1103 and 1106 provides a compact size for the capacitance.

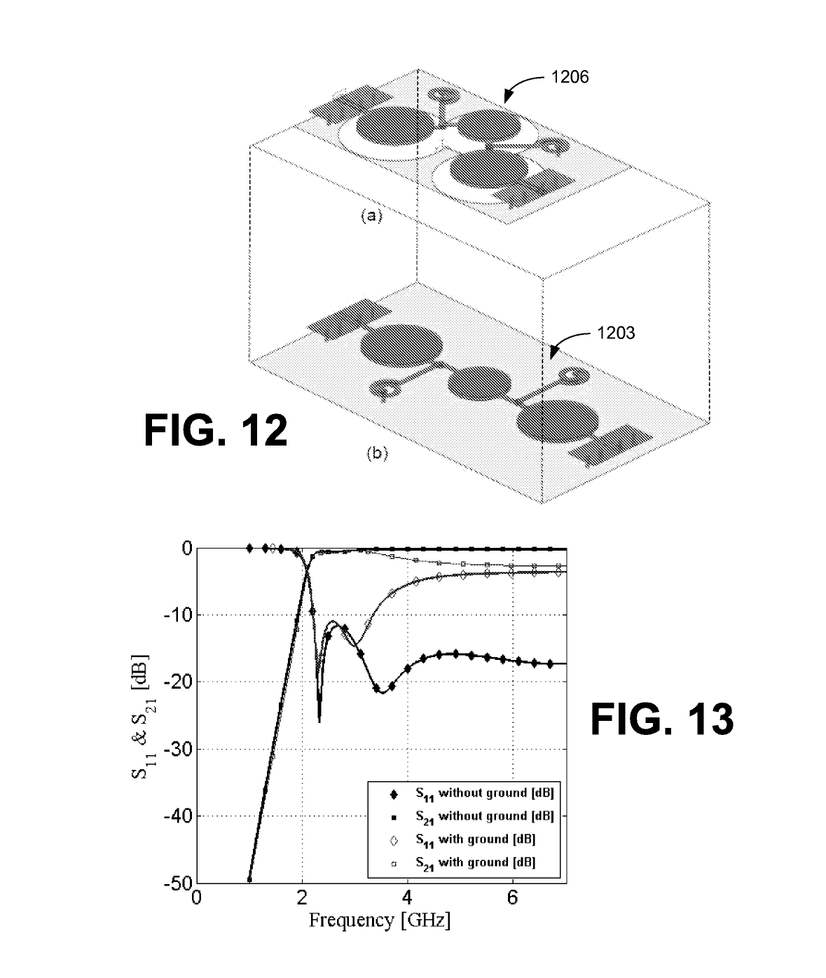

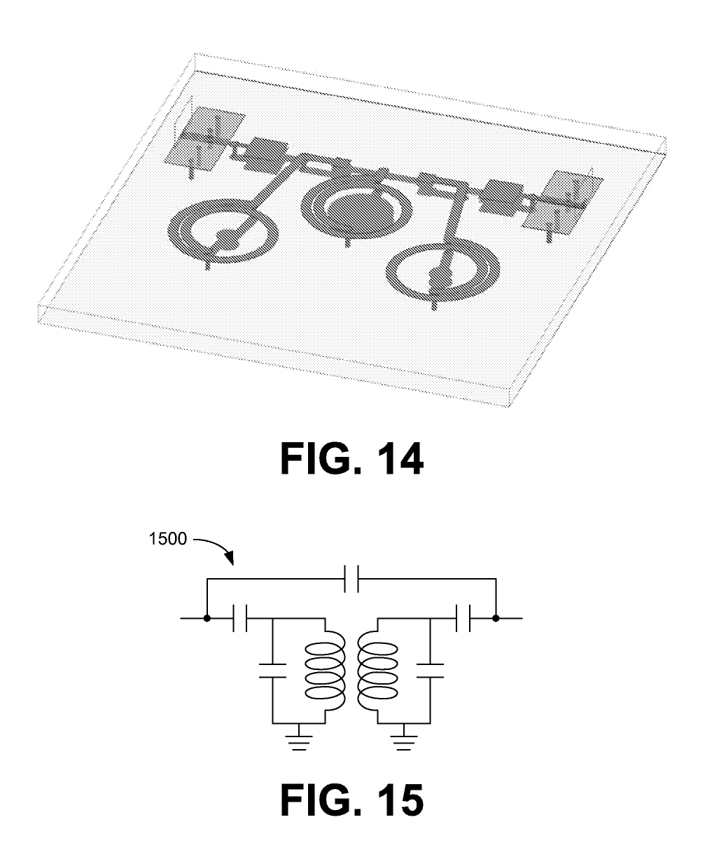

Circuits such as, e.g., high pass, low pass, and band pass filters may be implemented using the LCP-based passive components described above or variations thereof. For example, two high pass filters were designed using the library presented to have a cutoff frequency of 2 GHz. FIGS. 12(a) and 12(b) illustrate the reduction in size of a filter implementation using LCP passive components. The filter 1203 shown in FIG. 12(b) is a direct implementation of a Chebyshev high pass filter with three poles. In FIG. 12(a), the components were rearranged to reduce the area of the filter 1206 by approximately 50%. The filter 1203 includes spiral inductors as illustrated in FIGS. 4(a) and 4(b) and circular plate VID capacitors as illustrated in FIG. 9(a). To improve the performance of the filter 1206 at high frequencies, the ground plane under the capacitors was removed to decrease coupling to the ground. The insertion and return losses of the filters 1203 and 1206 are shown in FIG. 13; one is for the case of the ground plane unbroken, and the other is when the ground under the capacitors is removed in filter 1206. The improved filter 1206 achieves an insertion loss of only 0.2 dBs, with a size of 6 mm×4 mm. This filter 1206 reflects the ability of the demonstrated library to realize passive circuits that require high Q factors, with small sizes. FIG. 14 illustrates another filter design implemented in LCP using spiral inductors illustrated in FIGS. 4(a) and 4(b) and VID capacitors illustrated in FIG. 9(a). In FIG. 14, the area of the filter is reduced by implementing circular VID capacitors below the spiral inductors.

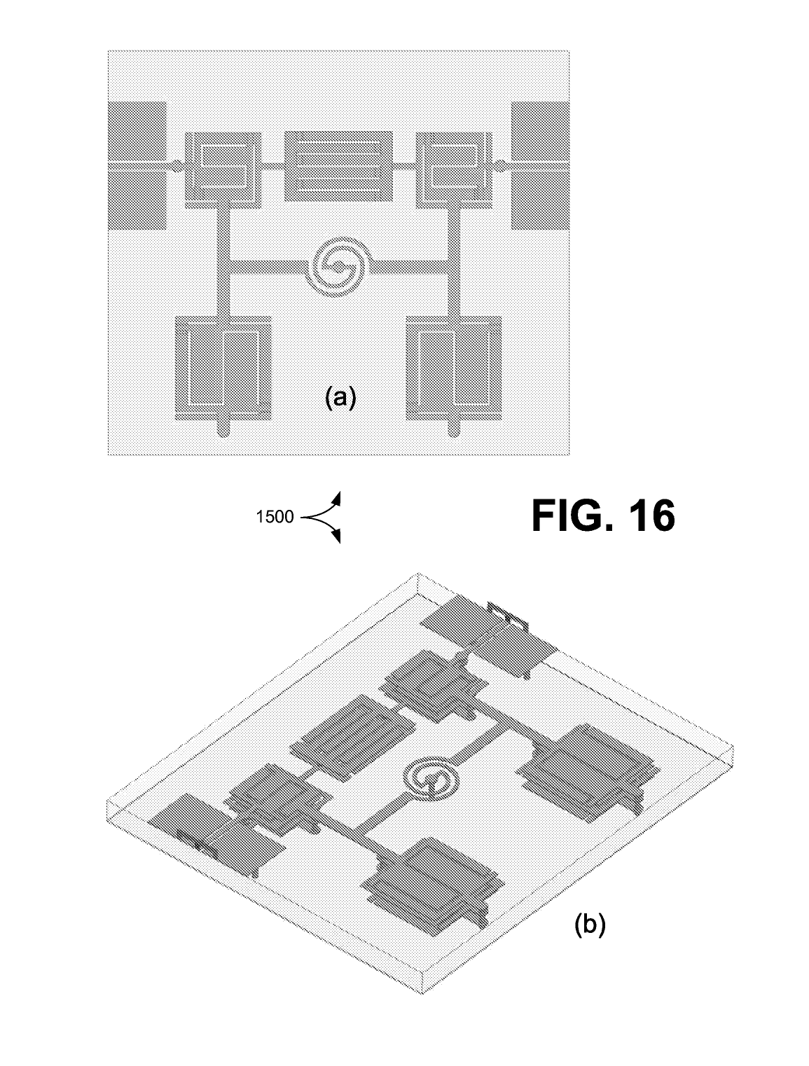

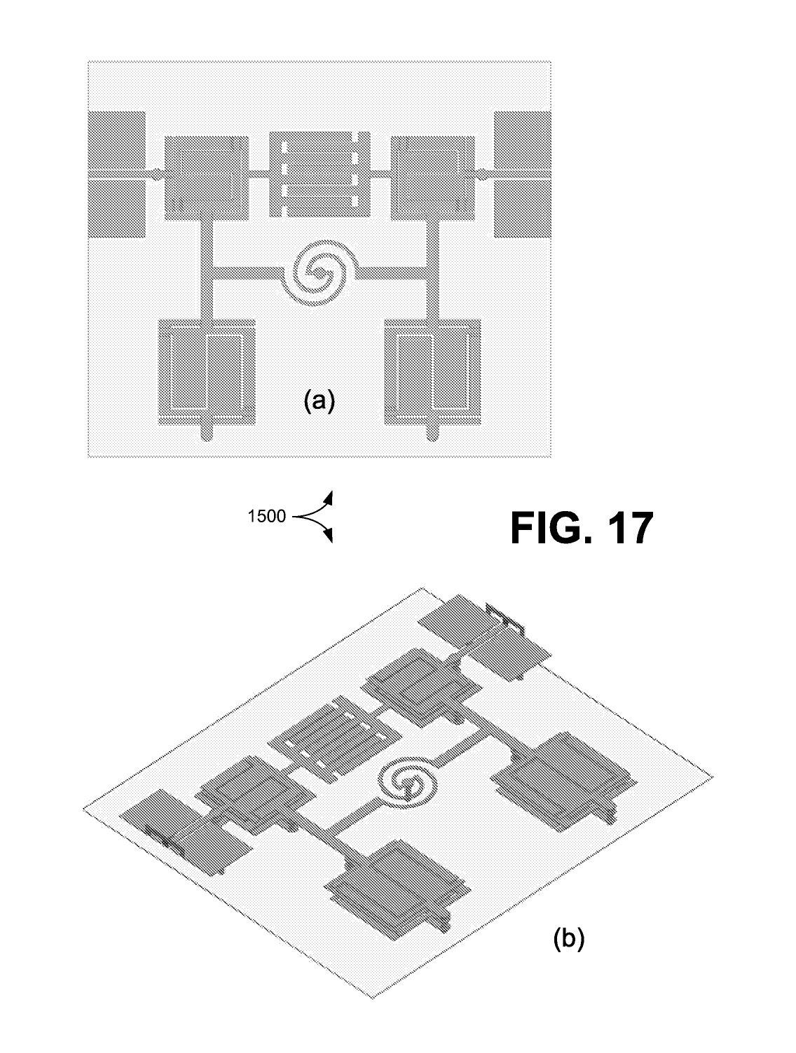

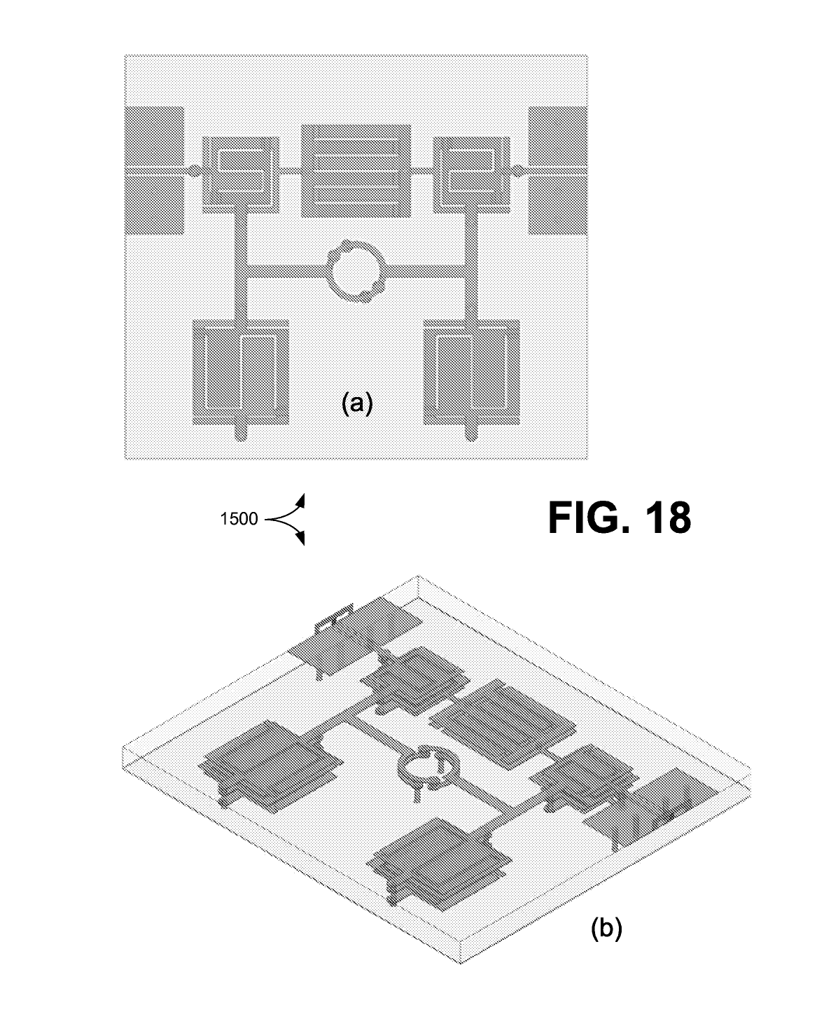

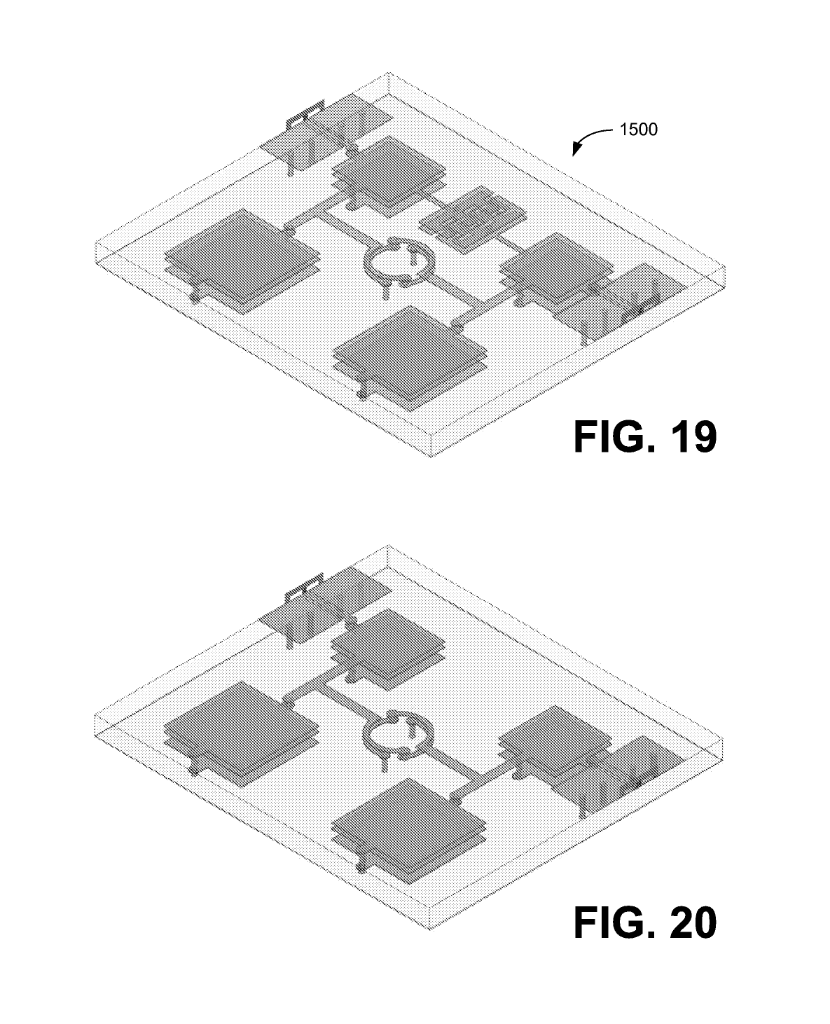

Other filters or circuits including passive components may also be implemented with LCP-based passive components. For example, FIG. 15 illustrates an example of a band pass filter design 1500 that can be implemented using LCP passive components. Referring to FIGS. 16-20, shown are examples of a band pass filter design 1500. FIG. 16 shows (a) a top view and (b) a perspective view of an implementation of the band pass filter 1500 with LCP-based passive components including a spiral inductor with concentrically spiraling circular inductors as illustrated in FIGS. 7(a)-7(c) and VID capacitors with interdigitated plates as illustrated in FIGS. 11(a)-11(c). FIG. 17 shows (a) a top view and (b) a perspective view of a variation in the implementation of the band pass filter 1500 of FIG. 16 with the coupling capacitor between the input and output connections implemented with a single layer interdigitized capacitor. FIG. 18 shows (a) a top view and (b) a perspective view of a variation in the implementation of the band pass filter 1500 of FIG. 16 with a vertically intertwined circular inductor of FIGS. 8(a) and 8(b). FIG. 19 shows a perspective view of a variation in the implementation of the band pass filter 1500 of FIG. 18 with rectangular plate VID capacitors as illustrated in FIG. 9(b). FIG. 20 shows a perspective view of a variation in the implementation of the band pass filter of FIG. 19 with the coupling capacitor between the input and output removed.

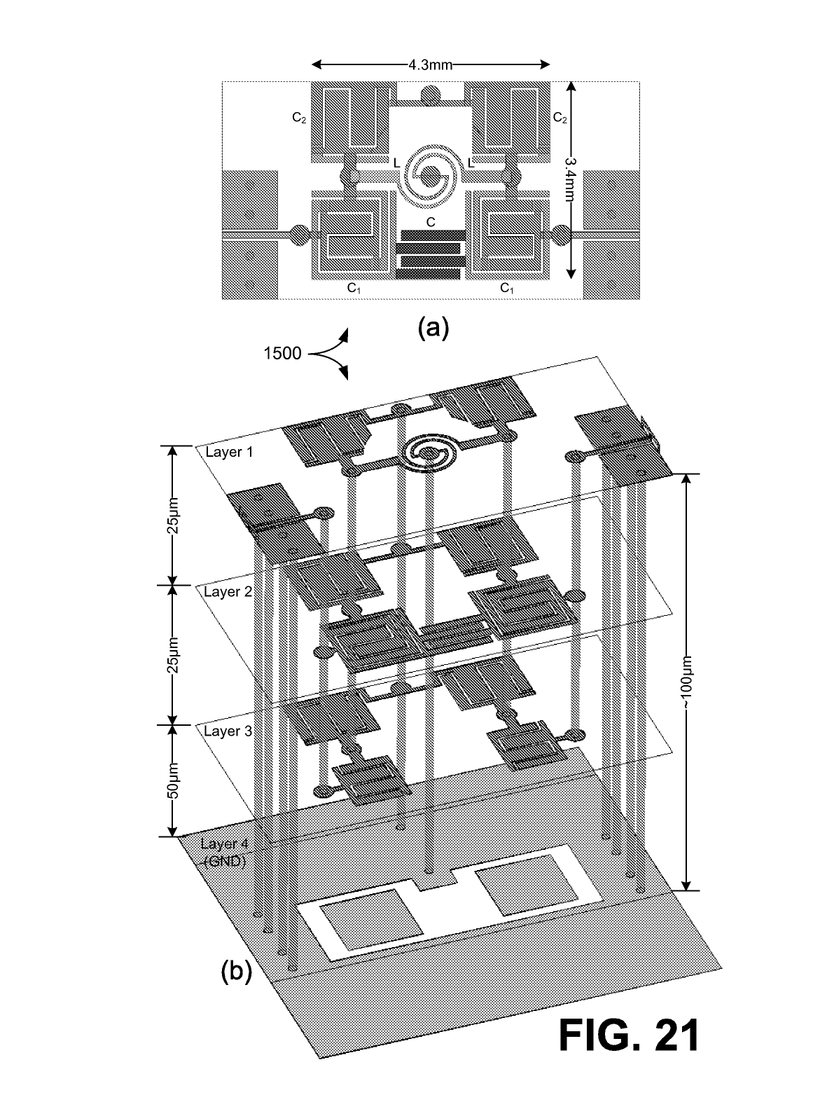

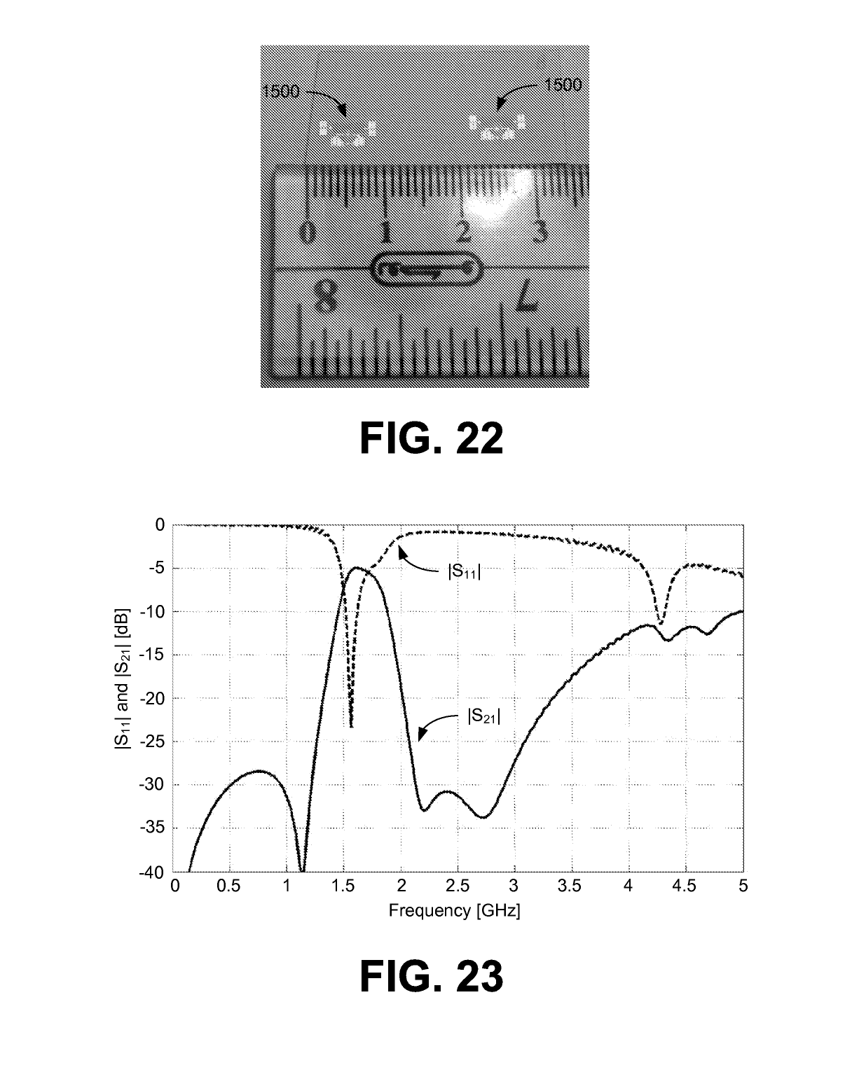

Referring to FIG. 21, shown are (a) a top view and (b) an exploded view of another implementation of the band pass filter 1500 with LCP-based passive components including a spiral inductor with concentrically spiraling circular inductors (L) as illustrated in FIGS. 7(a)-7(c) and VID capacitors (C₁ and C₂) with interdigitated plates as illustrated in FIGS. 11(a)-11(c). In the example of FIG. 21, capacitors C₁ are implemented on layers 2 and 3 and capacitors C₂ are implemented on layers 1 and 2. The band pass filter 1500 of FIG. 21 also includes spiraling circular inductors (L) are implemented on layer 1 and a coupling capacitor (C) between the input and output connections similar to FIG. 17, where the coupling capacitor is implemented with a single layer interdigitized capacitor on layer 2. FIG. 22 is a picture illustrating the scale of the implemented band pass filter 1500 of FIG. 21. The insertion and return losses of the pass filter 1500 of FIG. 21 are shown in FIG. 23.

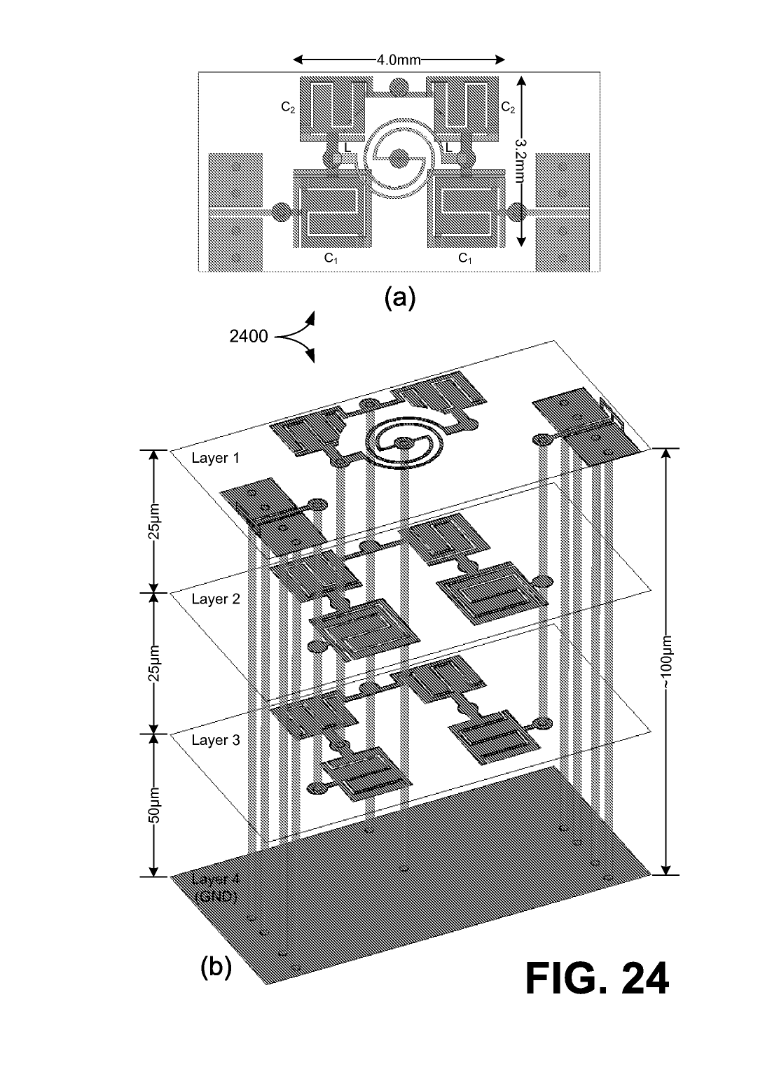

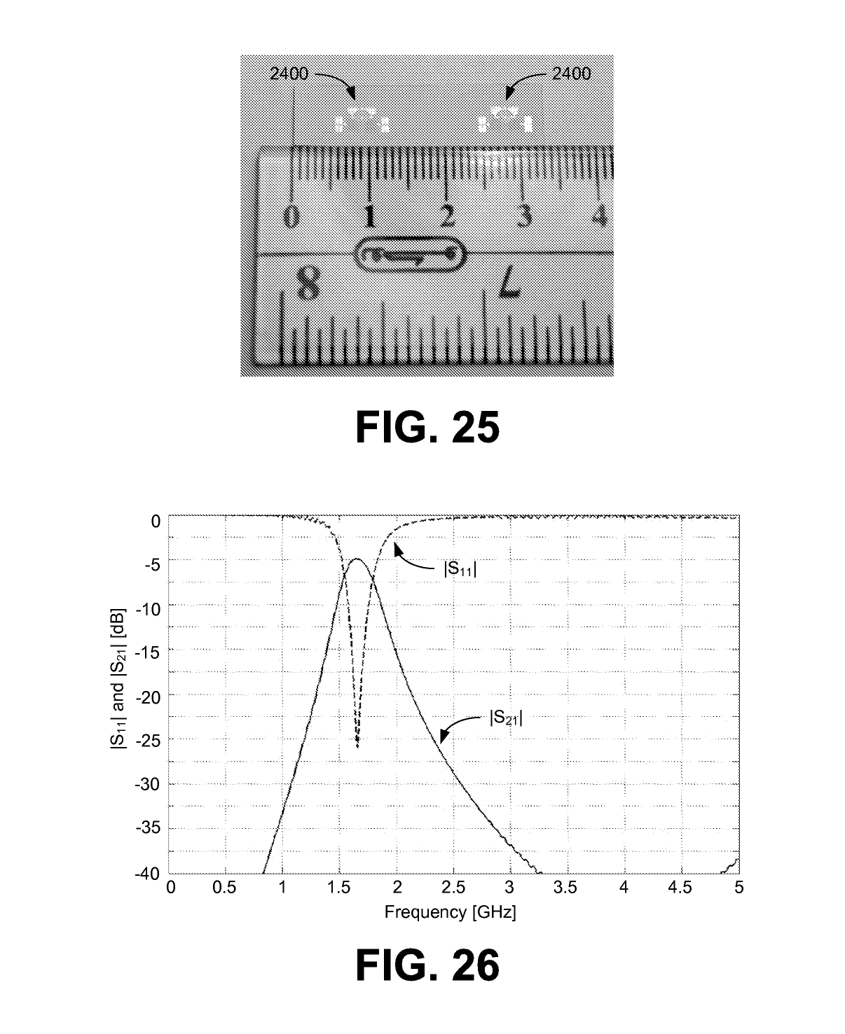

FIG. 24 shows (a) a top view and (b) an exploded view of an implementation of a band pass filter 2400 without a coupling capacitor between the input and output connections. As in the example of FIG. 21, capacitors C₁ are implemented on layers 2 and 3, capacitors C₂ are implemented on layers 1 and 2, and the spiraling circular inductors (L) are implemented on layer 1. Without the coupling capacitor, the overall size of the band pass filter 2400 may be reduced. FIG. 25 is a picture illustrating the scale of the implemented band pass filter 2400 of FIG. 24. The insertion and return losses of the pass filter 2400 of FIG. 24 are shown in FIG. 26.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, percentages, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a percentage range of “about 0.1% to about 5%” should be interpreted to include not only the explicitly recited percentage of about 0.1% to about 5%, but also include individual percentages (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A spiral inductor, comprising:
a center connection; and
a plurality of inductors formed on a liquid crystal polymer (LCP) layer, the plurality of inductors concentrically spiraling out from the center connection.

2. The spiral inductor of claim 1, further comprising a metallized via providing a connection path through the LCP layer to the center connection.

3. The spiral inductor of claim 1, wherein the plurality of inductors comprises two inductors that concentrically spiral out from the center connection.

4. The spiral inductor of claim 1, wherein at least one of the plurality of inductors comprises a number of turns (N) that is a fractional number of turns.

5. The spiral inductor of claim 1, wherein a first inductor and a second inductor of the plurality of inductors have a different number of turns (N).

6. A vertically intertwined inductor, comprising:
a first inductor including:
a first section disposed on a first side of a liquid crystal polymer (LCP) layer, the first section forming a fraction of a turn; and
a second section disposed on a second side of the LCP layer, the first section forming a fraction of a turn, the second section connected to the first section through a via passing from the first side to the second side through the LCP layer; and
a second inductor including:
a first section disposed on the first side of the LCP layer, the first section forming a fraction of a turn; and
a second section disposed on the second side of the LCP layer, the first section forming a fraction of a turn, the second section connected to the first section through a via passing from the first side to the second side through the LCP layer;
where at least a portion of the first section of the first inductor is substantially aligned with at least a portion of the second section of the second inductor and at least a portion of the first section of the second inductor is substantially aligned with at least a portion of the second section of the first inductor.

7. The vertically intertwined inductor of claim 6, wherein the first and second inductors are circular inductors.

8. The vertically intertwined inductor of claim 6, further comprising:
a third section of the first inductor forming a fraction of a turn, the third section connected to the second section of the first inductor through a via passing through another LCP layer, at least a portion of the third section of the first inductor is substantially aligned with at least a portion of the second section of the second inductor.

9. The vertically intertwined inductor of claim 6, further comprising:
a third section of the second inductor forming a fraction of a turn, the third section connected to the second section of the second inductor through a via passing through the other LCP layer, at least a portion of the third section of the second inductor is substantially aligned with at least a portion of the second section of the first inductor.

10. An adhesiveless multilayer LCP circuit comprising the inductor of claim 1 formed on one of a plurality of LCP layers.

11. The adhesiveless multilayer LCP circuit of claim 10, wherein the LCP layers include an ULTRALAM® 3850 layer and an ULTRALAM® 3908 bondply layer.

12. The adhesiveless multilayer LCP circuit of claim 10, wherein the LCP layers have different thicknesses.

13. The adhesiveless multilayer LCP circuit of claim 10, further comprising a vertical interdigitized (VID) capacitor including a plurality of plates separated by at least one LCP layer, preferably at least three plates separated by LCP layers.

14. The adhesiveless multilayer LCP circuit of claim 13, wherein the VID capacitor includes a plurality of levels of interdigitated plates.

15. The adhesiveless multilayer LCP circuit of claim 10, wherein the circuit is a radio frequency (RF) filter.

16. An adhesiveless multiplayer LCP circuit comprising the inductor of claim 6 formed on one of a plurality of LCP layers.

17. The adhesiveless multilayer LCP circuit of claim 16, wherein the LCP layers include an ULTRALAM® 3850 layer and an ULTRALAM® 3908 bondply layer.

18. The adhesiveless multilayer LCP circuit of claim 16, wherein the LCP layers have different thicknesses.

19. The adhesiveless multilayer LCP circuit of claim 16, further comprising a vertical interdigitized (VID) capacitor including a plurality of plates separated by at least one LCP layer, preferably at least three plates separated by LCP layers.

20. The adhesiveless multilayer LCP circuit of claim 16, wherein the VID capacitor includes a plurality of levels of interdigitated plates.
